(19) United States
(12) Patent Application Publication
(10) Pub. No.: US 2008/0188390 A1
(43) Pub. Date: Aug. 7, 2008

(54) COGRANULE FOR USE IN SOLID DETERGENT COMPOSITIONS

(76) Inventors: Frank Schinkel, Hamburg (DE); Cecilia Johansson, Helsingborg (SE); Ajse Sandqvist, Helsingborg (SE)

Correspondence Address: CANTOR COLBURN, LLP, 20 Church Street, 22nd Floor, Hartford, CT, 06103, US

(21) Appl. No.: 12/024,331

(22) Filed: Feb. 1, 2008

(30) Foreign Application Priority Data
Feb. 2, 2007 (EP) 07101646.3

(51) Int. Cl. C11D 3/02

(52) U.S. Cl. 510/224; 510/444

(57) ABSTRACT

The invention refers to a solid compact cogranule suitable for use in solid detergent compositions and especially in tablet applications. These cogranules have a granule size from 300 μm to 1400 μm and a bulk density of at least 750 kg/m³, and they comprise alkali metal silicate, carbonate, citrate, and less than 25% water by weight of the cogranule. A method for producing the granule is described.

### FIELD OF THE INVENTION

The present invention relates to detergent ingredients, in particular a silicate based cogranule suitable for use in solid detergent compositions and to a method for preparation thereof.

### BACKGROUND

Alkali metal silicates, carbonates, and citrates are commonly used ingredients in detergent formulations. Silicates provide, for example, good anti-corrosion, building, soil suspension and bleach stabilizing properties, especially when used in high doses and different SiO₂:M₂O ratios. The abrasive effect of silicates is generally welcomed in order to clean washing machines. However, too high concentration of silicate may cause glass corrosion in dishwasher applications. The use of soda is limited by its low effectiveness compared to other builders. The use of citrate is limited mainly due to its price/performance ratio.

However, such silicates typically tend to have decreased solubility and are thus used in combination with water soluble salts such as alkali metal carbonates. The use of various single admix substances require separate handling of the used precursors, separate storing before admixing and a mixing step at the point of detergent formulation completion. By combining the different precursors into mixed material cogranules, the production process of solid detergent formulations is simplified as storage, mixing and handling of all raw materials separately may be substituted by a single cogranulate addition.

U.S. Pat. No. 5,547,603 discloses a cleaning agent composition which comprises a solid alkali metal silicate having a molar ratio SiO₂:M₂O from about 1.5 to about 3, wherein the silicate also contains sodium carbonate (7-20%) and water (14-22%). In one embodiment a compacted silicate granule was preferably prepared by introducing sodium and/or potassium carbonate into an aqueous silicate solution and subsequently spray drying the mixture into a powder in order to enhance the bulk density of the powder. The dishwasher agent composition comprising the silicate and carbonate containing granules thus prepared may further contain various other useful separate chemicals such as complex-binding agents like phosphates, citrate, polyacrylate or zeolite which is commonly the case. The results provided rate of dissolution determined according to ISO 3123-1976 (E), which showed dissolution times of several minutes such as from 470 sec to 530 sec.

WO02090487 discloses similarly to U.S. Pat. No. 5,547,603 a granular alkali metal silicate and carbonate containing granules used as builders in detergent compositions. By closely controlling the specific composition of the granules a product was obtained which has a high silica equivalent content, good dissolution property and a low caking tendency. In these granules the molar ratio SiO₂:M₂O is in the range of 2.4:1 to 3.0:1 and they contain at least 30% silicate, less than 35% sodium carbonate (7-20%) and less than 25% water. The average granule size is in the range of 150 to 1400 μm and the bulk density of the granules is in the range of 750 to 1400 kg/m3. The dissolution tests show that the dissolution rate obtained was in the order of a few minutes, such as from 3 to 4 minutes.

A faster dissolution time is required for better supporting the washing process. Consumers often complain about not completely dissolved automatic dishwasher tablets which remain in the corresponding chamber of the dishwashing machine after the wash cycle. Furthermore, when incorporated in a detergent tablet the quality of the granule needs to be improved in terms of tablet hardness, brittleness and storage stability due to swelling.

WO03014285 relates to liquid detergent compositions with low-density particles, especially non-aqueous liquid laundry detergent compositions which do not display deleterious separation or segregation phenomena. For reducing the density of the dense non-surfactant ingredients having an initial density of about 1700 kg/m³ or greater a claimed method for forming hollow-core particles is provided. These dense ingredients are selected from detergency builders, such as maleic acid—acrylic acid copolymer, and alkalinity sources, such as water-soluble citrates, carbonates, silicates and mixtures thereof. A pumpable fluid comprising the binding agent and the water soluble detersive ingredient and water is dispersed via a rotary atomizer into a spray-dry tower to form droplets. Water is subsequently evaporated by contacting the droplets with at least 200° C. hot air. The product resulted in the form of a dried powder of considerably lowered bulk density of 1500 kg m³ or less due to hollow structure and a particle size from about 1 μm to 200 μm, the mean particle size being typically of the order of 50 μm, such as 51 μm to 67 μm as shown by an example.

The method for producing hollow core light particles is quite complicated albeit necessary to achieve the density decrease for the dense builders unsuitable as such for liquid detergent formulations. The small particle size powder obtained by this particular method of spray drying is well suited for liquid detergent purposes but inconvenient for solid detergent composition purposes. A particle size of about 50 μm is far too small for powder or tablet application. Dust formation could cause serious problems in production and increase in maintenance and operating costs and the physical properties of tablets would be poor. High dust formation during handling also forms serious health and environmental problems.

There are patent publications disclosing several ways of achieving mixed granules, or more accurately mixed material agglomerates, containing carbonate, citrate and/or silicate salts together in particulate form such as DE19640759, EP0551670, U.S. Pat. No. 412,799 and EP799886. These agglomerates have due to their preparation methods a chemically nonhomogenous compound structure, limited granule stability, a tendency to disintegrate into corresponding precursor particles or have problems with attrition, dusting, brittleness or lacking hardness during or after their further processing into tablets.

The object of the present invention is to provide an easily handled, low dusting silicate based cogranule suitable for use in solid detergent formulations, especially for tablet compositions.

Another object of the present invention is to provide a rapidly dissolving silicate based cogranule.

Yet another object of the present invention is to provide a simple and economical method for preparation of such a rapidly soluble silicate containing cogranule.

A further object of the present invention is to provide a detergent composition, especially an automatic dishwasher tablet composition comprising a rapidly dissolving silicate cogranule.

### BRIEF DESCRIPTION OF THE INVENTION

The present invention provides a solid compact cogranule comprising alkali metal silicate, carbonate, citrate, and water. The cogranule has a granule size from 300 μm to 1400 μm and a bulk density of at least 750 kg/m³. The cogranule comprises less than 25% water by weight.

Additionally, the present invention provides a method for preparation of the cogranule, comprising:
a. dissolving the alkali metal silicate, carbonate, and citrate into water to obtain a mixed salt liquid slurry;
b. forming compact granules by granulation using the mixed salt liquid slurry of step a; and
c. collecting the formed product of cogranules after sieving.

Further, the invention provides a detergent composition comprising the cogranules, and the use of the cogranules comprising alkali metal silicate, carbonate, citrate, and water in solid detergent compositions.

### BRIEF DESCRIPTION OF THE DRAWINGS

FIG. 1 illustrates the compact, homogenous structure of a cogranule;

FIG. 2 is a pictorial representation of “blackberry structure” granules and “onion” structure granules, and respective methods for their formation;

FIG. 3 illustrates the effects of a four-week exposure to warm, humid air on tablets whose preparation is described in Example 6;

FIG. 4 is a plot of weight gain (in weight percent) versus exposure time (in hours) to warm, humid air, as described in Example 4.

### DETAILED DESCRIPTION OF THE INVENTION

It was surprisingly observed that cogranules made by adding citrate into silicate and carbonate mixture, showed a rapid dissolution in water together with good mechanical granule properties. These cogranules were found to provide solid detergent compositions with a suitable source of water soluble silicate.

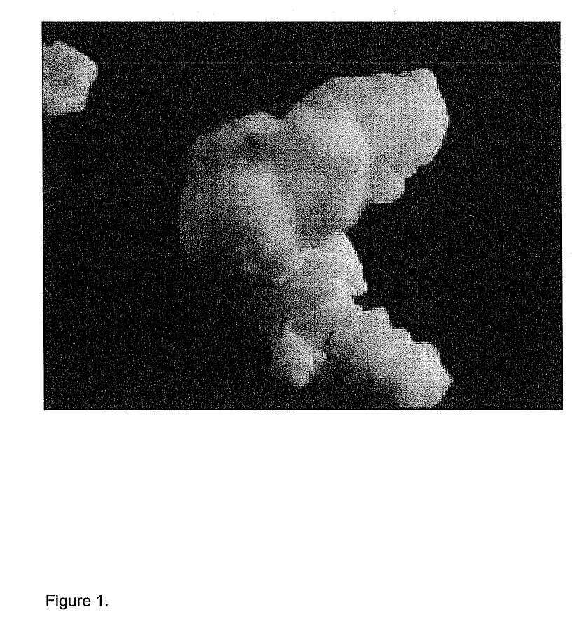

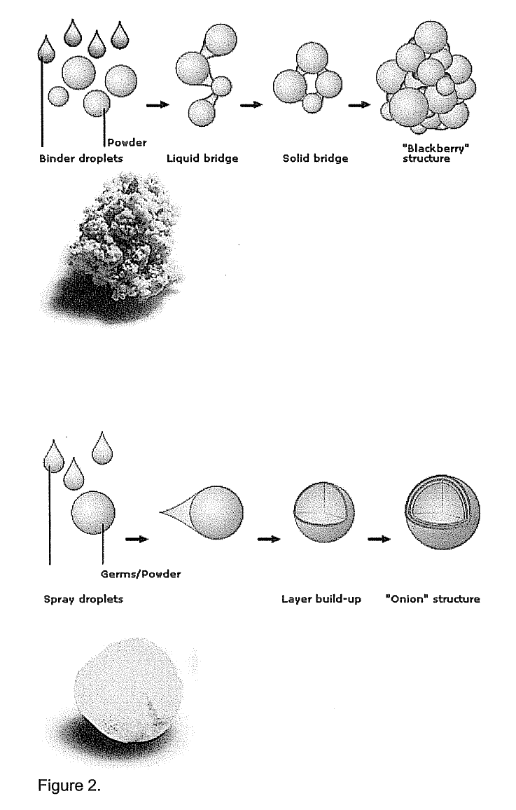

According to the invention a solid compact cogranule wherein the essential components are uniformly mixed throughout the whole granule is provided. FIG. 1 shows the compact, homogenous structure of the cogranule. The term “compact” is used for describing the dense solid structural property of the cogranule in contrast to possible porous or hollow structures or structures having voids. By the term “solid compact cogranule” is meant a single granule which comprises homogenously all the three mentioned essential components, silicate, carbonate and citrate, thus forming a “cogranule” of these compounds. Furthermore, as these cogranules are produced by a method such as fluid bed spray granulation from a liquid phase precursor comprising in dissolved state all the three essential components, silicate, carbonate-and-citrate, “solid compact” hard cogranules of homogenous chemical structure, i.e. the “onion” structure (lower half of FIG. 2) are formed in comparison to loosely bound single components such as aggregates, agglomerates or together pressed particulate granules which are typically referred to as the “blueberry” structure (upper half of FIG. 2). The hardness of the prepared cogranule equals that of a single compound granule. Breaking of this type of solid compact cogranules by a pressing force leads to particle pieces of homogenous chemical composition contrary to breaking of aggregates, agglomerates or pressed particulate granules which lead to segregation of the chemically different precursor materials. The granulation technology and typical examples of product structures obtained are depicted well by FIG. 2 extracted from the company Glatt GmbH's internet pages http://www.glatt.com/e/01_technologien/01_{—}03_{—}02_{—}03.htm and http://www.glatt.com/e/01_technologien/01_{—}03_{—}02_{—}01.htm. The dense structure of the cogranules supports the enhanced physical properties of the detergent compositions especially in applications such as tablets. This homogenous solid compact and dense cogranule structure is obtained by granulation from mixed salt liquid slurry or solution comprising all three essential components silicate, carbonate and citrate, and obtainable by e.g. a spray granulation process as described below.

The cogranule of the invention has a particle size from 300 μm to 1400 μm, preferably from 300 μm to 1000 μm, more preferably from 300 μm to 800 μm, for obtaining a better compatibility with other detergent ingredients, such as those in high quality tablets, and most preferably from 400 μm to 600 μm for better handling due to decreased dust formation.

The particle size should be compatible with the particle size of the other ingredients within the solid detergent composition to avoid material separation or segregation due to e.g. gravity during transportation or storage. In the cogranules of the present invention the size together with mechanical strength facilitate the manufacturing of tablets by pressing, decrease dust formation and enhance the stability of the product in hot and humid ambient condition.

According to a preferred embodiment of the invention the particle size distribution is controlled by sieving and the cogranule composition has a particle size distribution such that at least 90 % by weight of the granules are in the range from 400 μm to 600 μm. During production sieving is typically used to exclude cogranules smaller than 300 μm and larger than 1400 μm for allowing better physical properties for use in e.g. tablet applications.

The cogranule according to the present invention comprises three essential chemical components:

(i) alkali metal silicate,

(ii) carbonate, and

(iii) citrate,

which are granulated from a mixed salt liquid slurry containing these three components and some water.

The alkali metal silicate is preferably sodium or potassium silicate or a mixture thereof. The alkali metal silicate has a molar ratio SiO₂:M₂I, where M is an alkali metal, in the range from 1.6:1 to 3.4:1, preferably from 1.9:1 to 2.1:1 for avoiding too low alkalinity and yet providing good producibility. The amount of alkali metal silicate in the cogranulate is at least 5% by weight of the cogranule, preferably from 5% to 25% in order to achieve reasonable abrasive effect and alkalinity for the cogranule, more preferably from 9% to 20%.

As alkali metal silicate is a hydrophilic substance, the swelling and caking of the granules solely consisting of silicates during storage often have an unfavorable effect in detergent formulation. These swelling and caking phenomena due to uptake of humidity from air are especially pronounced for laundry and automatic dishwasher detergents, especially in applications like tablets. This behavior is significantly reduced by introduction of carbonate and/or citrate salt as granule ingredient into the silicate granules.

The carbonate salt is preferably an alkali metal carbonate. More preferably it is selected from sodium carbonate, potassium carbonate, ammonium or substituted ammonium carbonate, and mixtures thereof. Most preferably the alkali metal cation is sodium. The amount of alkali metal carbonate in the cogranulate is at least 10% by weight of the cogranule, preferably from 10% to 50% due to cost reasons, more preferably from 15% to 40%.

The cogranules of the present invention may include some impurities. The amount of these impurities is typically below 100 parts per million by weight (ppm). For example, iron is present preferably in amount of less than 45 ppm. Too high iron content is known to cause problems with a bleach component such as sodium carbonate assisting in decomposition thereof. Minor amounts of chlorides, oxalates, and/or sulfates may be present, as well.

For enhancing the rate of dissolution further and suppressing the unfavorable properties associated with silicate components it is necessary to add citrate into the granules comprising silicate and carbonate. By addition of citrate into this granule composition an increase by a factor of two is gained for the rate of dissolution.

The citrate to be incorporated into the cogranule is preferably an alkali metal citrate. It is also possible, but to some extent complicated, to use citric acid as such or together with a suitable reactant due to its pH value. More preferably the citrate is selected from sodium citrate, potassium citrate, lithium citrate, and mixtures thereof. Most preferably the alkali metal cation is sodium. The amount of alkali metal citrate in the cogranule is at least 10% by weight of the cogranule, preferably from 20% to 60% limited by the desired end application demands, more preferably from 25% to 50%.

The cogranule according to the invention always contains some water due to the processing for its manufacture. The water content of the cogranule is typically less than 25% by weight, preferably less than 20% to minimize the drawbacks in physical properties of the cogranules such as stickiness. Usually the amount of water is at least 5%, preferably at least 10% depending on the optimum preparation parameters and apparatus used. Most preferably the water content of the cogranule is from 10% to 20% by weight of the cogranule.

The cogranules of the present invention are particularly useful in detergent compositions which have high bulk densities. The preferred bulk density depends on the end use so that the bulk density is similar to that of the other ingredients which helps to avoid separation in the end product and aids in suppressing dusting tendency. The cogranules of the present invention have a bulk density of at least 750 kg/m³, preferable at least 800 kg m³, such as 900 kg/m³ depending on the aimed end product. Usually, the upper limit for bulk density is 1400 kg/m³, preferably less than 1100 kg/m³, such as 1000 kg/m³ which is close to an average value of that of the aimed end products.

In a preferred embodiment the bulk density is at least 800 kg/m³ when the cogranules are used in automatic dish washer detergent compositions. Preferably, the bulk density is between 800 kg/m³ and 1100 kg/m³ when the cogranules are used in tablet applications, especially in automatic dishwasher detergent tablet applications.

In one embodiment of the invention the cogranule bulk density is from 750 kg/m³ to 1000 kg/m³. Cogranules of this type are especially well suited for detergent compositions aimed to be used in fabric washing.

The cogranules of the invention have the advantage that they dissolve rapidly in water and that the dissolution rate is clearly enhanced when citrates, preferably alkali metal citrates, are incorporated into the cogranules. The dissolution rate of particles provided by the present invention measured as defined in WO02090487 is less than 1 minute, preferably less than 50 seconds.

In one embodiment of the invention the cogranules contain in addition to the three essential components an organic builder ingredient commonly used in detergent formulation, such as polycarbonate, polyacrylate, copolymers of acrylate and/or maleate, succinates, malonates, ascorbates, fatty acids, carboxymethyl succinates, polyacetyl carboxylates, alkali metal salts of oxydisuccinic acid, mellitic acid, benzene polycarboxylic acids, carboxymethylcellulose (CMC), polysaccharide based polycarboxylates, organic phosphonate type sequestering agents or alkanehydroxy phosphonates, preferably polysaccharide based polycarboxylates.

In another embodiment of the invention, liquid ingredients such as organic chelating agents, surfactants, or enzymes are incorporated into the cogranule. The cogranules according to the invention are able to carry a much higher amount of liquid ingredients such as organic chelating agents, surfactants or enzymes than the single silicate granules. In the present invention the amount of organic chelating agent included in the granule is preferably between 0.1% and 10% by weight of the cogranule. So far, the measured known silicate based cogranules have been shown to contain up to 8% liquids, whereas the cogranules of the present invention have shown to contain liquids of about 16%.

The granules are free flowing, odourless, and white. They provide a low dusting property and are convenient for use in compositions requiring pressing e.g. into tablets. The storage stability of the cogranules was found to be improved compared to granules known in the art without the citrate component.

According to the invention a method for producing of the solid, compact cogranules is provided. This method comprises dissolving the alkali metal silicates, carbonates and citrates into water to obtain a mixed salt liquid slurry or solution, forming compact granules by granulation using this slurry, and subsequently collecting the formed product of cogranules after sieving.

By the term “slurry” is meant a thick solution of several solids. The water content thereof being at least 30% by weight, preferably at least 40% by weight for the viscosity to allow reasonable pumping and spraying, more preferably at least 50% by weight depending on the ratio of the three components used. Most preferably the water content is at least 55% facilitating easy spraying and handling of the aqueous phase without any clogging in the used spraying apparatus. The outmost form of this slurry is a solution. A saturated solution which can be pumped and sprayed is preferred. It is possible to use a thick slurry which typically leads to the lowest possible energy consumption in evaporation. The slurry is usually heated up for enhancing the solubility and viscosity. This may result in over saturation causing precipitation. As a non-homogenous slurry cannot guarantee the cogranules a consistent precursor ratio, agitation of the slurry is preferably required. The slurry may comprise dissolved precursor species, non-dissolved or precipitated precursor species, or fine insoluble impurities, but it must withstand pumping and spraying.

In the first step the three essential components, alkali metal silicates, carbonates and citrates are dissolved into water, thus forming the mixed salt liquid slurry. The dissolution is preferably made by first dissolving the carbonate and citrate and subsequently adding the silicate. The solvent is at elevated temperature, preferably at least 50° C., more preferably at least 70° C. Agitation is typically applied during the dissolution. There may be some evaporation of solvent during the dissolution. Apparatus known in the state of the art is used for the dissolution.

In one embodiment an organic builder ingredient such as a polymer is added into the cogranule. This polymer is preferably dissolved into the clear aqueous solution of carbonate and citrate before adding the silicate for generating a homogeneous distribution.

After dissolution, the aqueous slurry is fed into a granulation apparatus. Granulation is carried out by known methods and known apparatus suitable for granulation, for example in a fluidized bed spray granulator or drum granulator. Preferably, the granulation is performed in a fluidized bed spray granulator, more specifically in a horizontal fluidized bed spray granulator which was found to produce the best quality granules. Cogranules prepared in fluidized bed spray granulator showed the least hygroscopicity and highest bulk densities and good hardness of the granules. The use of a horizontal fluidized bed spray granulator in continuous mode comprises a start up procedure before the continuous operation. The temperature during the granule formation is preferably below 100° C., more preferably 80° C. or less.

The granulation process includes drying and sieving in order to collect the desired particle size fraction wherein the particle size is from 300 μm to 1400 μm, preferably 1000 μm. The undersized particles, the particle size of which is less than 300 μm, may be circulated back to granulation process as seeds for further growing. The oversized particles, with particle size more than 1400 μm, preferably more than 1000 μm, are first milled and then circulated back to granulation process. Alternatively, the undersized particles, the oversized particles, or both may be circulated back to the dissolution step.

The invention provides further a novel solid detergent composition which contains the cogranules comprising alkali metal silicate, carbonate, citrate, and water. The cogranules according to the invention are incorporated into detergent formulations as support components. Due to particle size and bulk density match and low dusting properties the cogranules offer an excellent vehicle for carrying liquid ingredients as well as providing a rapidly dissolving, easy to handle, single support source for alkali metal silicate.

Preferably the cogranules form part of the end formulation of a laundry detergent or a detergent application such as laundry detergent tablet, automatic dishwasher detergent powder, or a powder application such as automatic dishwasher detergent tablet, dry bleach product, or other detergent formulation where silicate, carbonate and citrate have earlier been in use as single components. The bulk density in these applications is preferably between 750 kg/m³ and 1100 kg/m³.

In a preferred embodiment an automatic dishwasher tablet is produced comprising cogranules of alkali metal silicate, carbonate, and citrate together with other typical tablet detergent components.

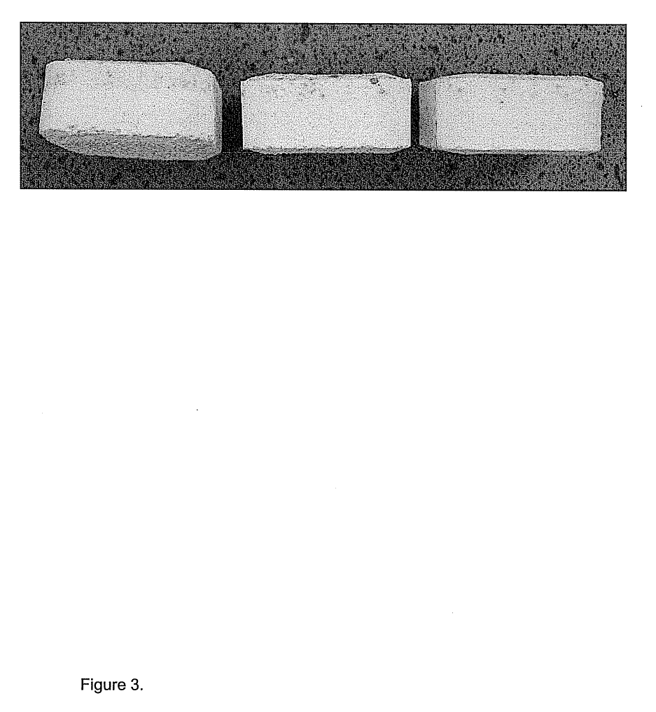

The use of the solid compact cogranules of the present invention provides good quality detergent tablets with high tablet storage stability. These tablets are less sensitive to deformations typically due to hygroscopicity and swelling as shown in FIG. 3 compared to the use of powder precursor materials. Furthermore, there has been observed no negative effects due to possible interactions with the used cogranules with other ingredients in the automatic dishwasher detergent tablets.

Yet, the use of the solid compact cogranules of the present invention provides much harder tablets due to the hard and stable nature of the cogranules. Tablets produced with identical tableting pressure tend to withstand more than 50% more pressure before breaking down when containing the cogranules compared to standard commercial tablets (see example 7).

The use of the solid compact cogranules of the present invention in detergent tablets provides less brittleness. The tendency of the tablets to break or form crumbs is lowered at least by 50% (see example 8) compared to standard commercial tablets.

In another preferred embodiment a laundry tablet is produced comprising cogranules of alkali metal silicate, carbonate, and citrate together with other typical tablet detergent components.

The cogranules of the present invention may be used in any solid detergent composition or application for enhancing the dissolution rate of silicate. Furthermore, the cogranules of the present invention may be used in any solid detergent composition or application for facilitating an easy handling of the required starting compounds, now encased into one single multicomponent cogranule. Especially, when used in fabric washing detergent the preferred bulk density is from 750 kg/m³ to 1000 kg/m³.

The invention is further illustrated by the following examples which are not intended to be limiting in scope.

### EXAMPLES

### Example 1

Cogranules comprising silicate, citrate and carbonate are prepared by the following procedure:

A dissolving vessel equipped with an agitator and direct heating/cooling system is filled up with 8860 kg of water. The agitation is started and the content is heated up to 50° C. Soda ash (anhydrous sodium carbonate, granular HSB grade, Brunner Mond, NL), 1700 kg, sodium citrate dihydrate (USP, FCC, BP 2000, Gadot Biochemical Industries Ltd.), 3000 kg, and 40% sodium silicate solution, 1890 kg are introduced into the vessel, which is heated further up to 90° C., agitated until the solution becomes homogeneous and cooled down to 70° C. forming a slurry.

The cogranules are prepared from the slurry in a horizontal fluid bed granulator. After start-up phase of the granulator the granulation process is continuous. Liquid slurry is sprayed into the granulator with a spraying rate of 870 I/h and the air flow through the bed is about 25,000 Nm³/h. The product cogranules are taken out and off spec cogranules from the sieving machine, that is, those >900 μm and <300 μm, are milled and fed back to the granulator as seeds. Bed volume is regulated by measuring the differential pressure over the bed and keeping it at the same level and the bed temperature is maintained at 80° C. Product with the desired size, >300 μm and <900 μm, is taken. out from the sieving machine continuously.

### Example 2

Cogranules comprising silicate, citrate, carbonate, and a polymer are prepared by the following procedure:

A dissolving vessel equipped with an agitator and direct heating/cooling system is filled up with 8860 kg of water. The agitation is started and the content is heated up to 50° C. Soda ash, 1700 kg, sodium citrate dihydrate, 3000 kg, 40% sodium silicate solution, 1890 kg, and 104 kg of polysaccharide based polycarboxylate polymer (Kemira Oyj) 20% are introduced into the vessel, which is heated further up to 90° C., agitated until the solution becomes homogeneous and cooled down to 70° C. forming a slurry. Subsequently the cogranules are prepared as described in Example 1.

### Example 3

The dissolution of granules prepared in Example 1 and in Example 2 are measured. The used dissolution test is based on the increased conductivity due to dissolution of silicate. The method uses conductivity and the result is defined as the time for dissolving 90% by weight of the sample. First, a cogranule sample of 1.8 g is introduced into 1000 g of water at 20° C. Then 2.0 g sample is dissolved. The dissolution rate is defined by the time it takes to the two solutions to reach the same conductivity.

A cogranule containing 11.7% sodium silicate with a molar ratio SiO₂:M₂O 2:1 and 26.5% sodium carbonate and 46.7% sodium citrate and 15% water show a dissolution time of 31 sec.

A cogranule containing 11.6% sodium silicate with a molar ratio SiO₂:M₂O 2:1 and 25.9% sodium carbonate and 45.9% sodium citrate and 15% water and a 1.6% polymer coating show a dissolution time of 25 sec.

### Example 4

The stability of detergent tablets containing

a. cogranules produced in Example 1

b. cogranules from Example 2 including 2% of polysaccharide based polycarboxylate polymer.

c. commercially available single silicate, carbonate (anhydrous sodium carbonate, granular HSB grade, Brunner Mond, NL) and citrate granules (trinatriumcitrate dihydrate, USP, FCC, BP 2000, Gadot Biochemical Industries Ltd.)

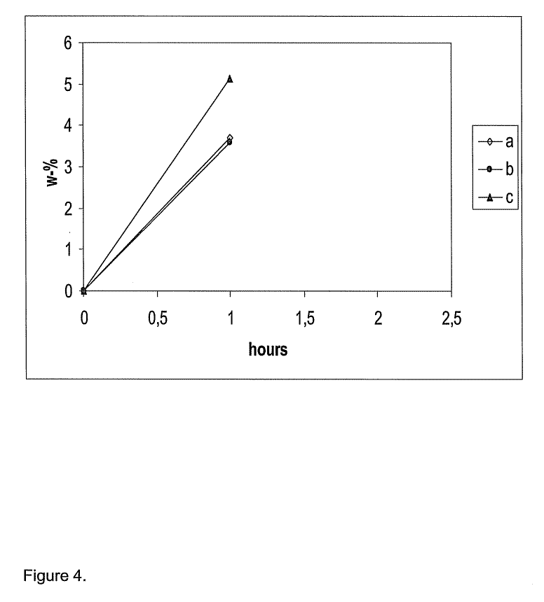

were measured by subjecting the detergent tablet into warm and humid condition in a climate chamber for four weeks. The temperature of the chamber was 37° C. and the relative humidity 70%. The stability results are shown in FIG. 4 as weight increase against the time inside the climate chamber.

The detergent tablets comprising cogranules of silicate, carbonate and citrate clearly gained less weight than the reference tablets.

### Example 5

The take-up ability of liquid ingredients was measured for samples d, e and f. Samples d and f are prepared according to example 1 with the exception that the samples contain 12% of the organic chelating agent already included inside the cogranule, and that sample d is made in a pilot plant size granulation equipment and that sample f is made in a laboratory size granulation equipment. Sample e is a commercially available two component (silicate and carbonate) granule (Rhodia).

A qualitative test includes adding dropwise an organic chelating agent, Lutensol, (BASF) onto the granules during stirring and testing the samples by sensory impression, by touching them. At the point of saturation the excess chelating agent will remain on the surface of the granules and cause a wet sensation. The results are shown in Table 1.

TABLE 1

| Sample | Amount of Lutensol (wt-%) |
|---|---|
| d | 12 + 4 pilot |
| e | 8 |
| f | 12 + 4 lab |

### Example 6

Three detergent tablets were prepared containing

A. 62% commercially available 1:2:3 silicate:soda:citrate powders and normal ingredients like surfactants, anti-foaming agents and antiscalant agent (reference),

B. 62% of the cogranules of the present invention 1:2:3 silicate:soda:citrate and normal ingredients like surfactants, anti-foaming agents and antiscalant agent,

C. 62% of the cogranule of the present invention 1:2:3 silicate:soda:citrate and normal ingredients like surfactants, anti-foaming agents and 2% antiscalant agent integrated in the cogranules.

These tablets were subjected to warm, 37° C. and humid, RH 70% conditions for four week after which the deformations were determined. It can be seen from FIG. 3 that the tablet A is considerably swelled and deformed compared to tablets B and C.

### Example 7

Three detergent tablets A-C were prepared the same way as in example 6.

These tablets were subjected to a standard breaking test using Schleuniger Pharmatron 8 M equipment. Tablet A was breaking at 90 N whereas sample B could withstand 160 N and sample C 120 N before breaking

### Example 8

The brittleness of the tablets A-C from example 7 was tested by measuring with the same equipment.

The determined friability of A was 40% whereas the friability of tablet B was only 9% and friability of tablet C 17%.

It is obvious that cogranules have a much smaller tendency to break under tableting pressure and accordingly form a much harder tablet. Also the homogenous form of the cogranule have much less attrition. The interaction of the single components (silicate/soda/citrate) with different cristal sizes and forms logically form more attrition and accordingly less hard and more brittle tablets.

1. A solid compact cogranule having a granule size from 300 μm to 1400 μm and a bulk density of at least 750 kg/m³; wherein the solid compact cogranule comprises an alkali metal silicate, a carbonate and a citrate; wherein the solid compact cogranule is granulated from a mixed salt liquid slurry comprising the alkali metal silicate, the carbonate, and the citrate; and wherein the solid compact cogranule comprises less than 25% water by weight of the cogranule.

2. The cogranule according to claim 1, comprising at least 5% of said alkali metal silicate by weight of the cogranule.

3. The cogranule according to claim 1, comprising from 5% to 25% of said alkali metal silicate by weight of the cogranule.

4. The cogranule according to claim 1, comprising at least 10% of said carbonate by weight of the cogranule.

5. The cogranule according to claim 1, comprising from 10% to 50% of said carbonate by weight of the cogranule.

6. The cogranule according to claim 1, comprising at least 10% of said citrate.

7. The cogranule according to claim 1, comprising from 20% to 60% of said citrate by weight of the cogranule.

8. The cogranule according to claim 1, wherein the alkali metal silicate has a SiO₂/M₂O ratio, where M is an alkali metal, of from 1.6:1 to 3.4:1.

9. The cogranule according to claim 1, wherein said alkali metal silicate is sodium silicate, potassium silicate, or a mixture thereof.

10. The cogranule according to claim 1, wherein said carbonate is an alkali metal carbonate selected from the group consisting of sodium carbonate, potassium carbonate, ammonium or substituted ammonium carbonate, and mixtures thereof.

11. The cogranule according to claim 1, wherein said citrate is an alkali metal citrate selected from the group consisting of sodium citrate, potassium citrate, lithium citrate, and mixtures thereof.

12. The cogranule according to claim 1, comprising less than 20% water by weight of the cogranule.

13. The cogranule according to claim 1, comprising at least 5% water by weight of the cogranule.

14. The cogranule according to claim 1, comprising at least 10% water by weight of the cogranule.

15. The cogranule according to claim 1, further comprising an organic chelating agent, a surfactant, an enzyme, or a mixture thereof.

16. The cogranule according to claim 1, further comprising an organic builder ingredient.

17. The cogranule according to claim 16, wherein the organic builder ingredient is a polysaccharide based polycarboxylate.

18. The cogranule according to claim 1, wherein the granule size is from 300 μm to 1000 μm.

19. The cogranule according to claim 1, wherein the granule size is from 300 μm to 800 μm.

20. The cogranule according to claim 1, wherein the granule size is from 400 μm to 600 μm.

21. The cogranule according to claim 1, wherein at least 90% of the granules are within the range from 400 μm to 600 μm.

22. The cogranule according to claim 1, wherein the bulk density is at least 800 kg/m³.

23. The cogranule according to claim 1, wherein the bulk density is less than 1400 kg/m³.

24. The cogranule according to claim 1, wherein the bulk density is less than 1100 kg/m³.

25. A method for producing a solid compact cogranule comprising an alkali metal silicate, a carbonate, a citrate, and less than 25% water by weight of the cogranule, the method comprising:
a. dissolving the alkali metal silicate, carbonate, and citrate into water to obtain a mixed salt liquid slurry;
b. forming compact granules by granulation using the mixed salt liquid slurry of step a; and
c. collecting the formed product of cogranules after sieving.

26. The method according to claim 25 wherein particles less than 300 μm and more than 1400 μm are recycled back to step b and/or step a.

27. The method according to claim 25, wherein the granulation of step b is performed in a fluidized bed spray granulator.

28. The method according to claim 25, wherein the granulation temperature is less than 100° C.

29. A solid detergent composition comprising the cogranule of claim 1.

30. The solid detergent composition according to claim 29, wherein the bulk density of said cogranules is from 750 kg/m³ to 1000 kg/m³.

31. The solid detergent composition according to claim 29, wherein the solid detergent composition is in a form of a tablet.

32. The solid detergent composition according to claim 31 wherein said tablet is an automatic dishwasher detergent tablet.
